(19) United States
(12) Patent Application Publication
(10) Pub. No.: US 2006/0070987 A1
(43) Pub. Date: Apr. 6, 2006

(54) Monitoring device for welding wire supply

(75) Inventor: Joseph A. Daniel, Sagamore Hills, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: LINCOLN GLOBAL, INC.

(21) Appl. No.: 10/954,945

(22) Filed: Sep. 30, 2004

(51) Int. Cl. B23K 9/10

(52) U.S. Cl. 219/137.71

(57) ABSTRACT

A monitoring device for sensing of the actual amount of welding wire on a spool with a minimum wire supply diameter for use in a wire feeder of an electric arc welder, said monitoring device comprising: an RPM device to create a spool speed signal indicative of the rotational speed of the spool as the spool provides wire at the known wire feed speed and a converting device for converting according to a set relationship the spool speed signal into a wire supply signal varying between a high level when the spool speed signal is low at a presumed maximum supply of wire on the spool and a low level when the spool speed signal is high at the minimum supply of wire on said spool determined by the minimum wire supply diameter.

The present invention relates to electric arc welding of the type using a continuous supply of welding wire and more particularly to a monitoring device for the welding wire supply during operation of the welder.

### INCORPORATION BY REFERENCE

It is known to monitor the amount of wire in a supply drum from which wire is pulled by a wire feeder for use in an electric arc welder as shown in Blankenship U.S. Pat. No. 6,708,877, incorporated by reference herein as background information. The amount of wire in the drum supplying welding wire to the wire feeder is recorded on the drum and a measuring device measures the amount of wire used and subtracts this amount from the recorded amount of wire supplied with the welding wire drum. Similar devices have been suggested for weighing the spool or drum to determine when the weight is reduced to a low level. These two techniques for determining the amount of wire in a welding wire supply package are incorporated herein as background information.

### BACKGROUND OF THE INVENTION

In an electric arc welder, the welding wire is provided by a package mounted adjacent the welder and from which the wire is pulled by a wire feeder operated at a known speed (WFS). The present invention relates to a wire package in the form of a rotating spool or reel mounted adjacent the wire feeder and rotated as the wire feeder pulls the wire from the spool. This arrangement constitutes a very popular package for welding wire, even in highly automated welding operations, such as robot welding. The spool size may vary between a small spool for a smaller welding application to a big spool reaching a magnitude of over 60 pounds. The use of a spool as a package is convenient for storage and for general use on high production welders; however, when using a spool, serious problems occur when the supply of welding wire on the spool is unexpectedly exhausted. When the supply of welding wire in the welding arc is interrupted abruptly, the welding power source does not respond by turning off the output voltage. Consequently, the depletion of the welding wire from a spool often results to damage to the contact tip of the welding torch and possibly failure or rejection of the weld. This deficiency has substantial consequences when the welding operation is in a production line operated on the “just in time” basis. Consequently, it is essential to know when the supply of welding wire on a spool will be exhausted even though visual confirmation of the amount of welding wire is not possible. In many instances, the spool is in a housing or cabinet so it is not visible from the exterior of the welder. If the amount or quantity of the welding wire supply is known to the operator, the welding process can be stopped before any damage occurs and a full spool can replace the empty spool in a timely fashion. Consequently, it is desired that there be a mechanism so the operator knows the amount of welding wire on the rotating spool at any given time. Advance notice of the remaining welding wire on the spool can then be used effectively to request a new spool or efficiently plan the on-going production process. At this time, there is no device that can be associated with an electric arc welder to monitor the actual supply of welding wire available for the welding operation, except for a suggestion of weighing the spool and wire. Weighing the spool requires a complicated device for mounting the rotating spool on a scale mechanism. This arrangement is not acceptable. Another approach attempting to accomplish the objective of knowing the actual amount of welding wire is disclosed in Blankenship U.S. Pat. No. 6,708,877. This inventory control system requires a measurement of the actual wire in a drum so that a meter associated with the wire feeder can subtract the amount of wire used from the amount of wire in the drum. This system requires special drums and a reader for determining the actual amount of welding wire in the drum. There are advantages in the Blankenship approach, but it is not now employed for measuring the amount of wire on a rotating spool. It is disclosed for use in a drum package. The absence of a device to accurately inform an operator of the amount of wire available on a rotating spool is the background to which the present invention is directed.

### THE INVENTION

The invention involves monitoring the actual amount of welding wire on a rotating spool as the wire is pulled from the spool by the wire feeder of an electric arc welder. The spool is monitored during operation by determining a characteristic of the wire constituting the supply of wire at any given time. In the preferred embodiment of the invention, the monitoring signal is a relationship between the rotational speed of the spool and the wire feed speed of the wire feeder. In this operation, the minimum diameter of the spool must be known to determine the low level of the monitoring signal corresponding to an empty spool. A comparison of the wire feed speed and the rotational speed of the spool indicates the diameter of the actual wire supply. When this diameter reaches the minimum diameter of the spool, the spool is empty. Thus, the amount of wire available at any given time is displayable until the spool is empty. In accordance with an alternative version of the invention a device determines merely the diameter of the wire supply on the spool, together with the known minimum diameter of the spool. A signal between the presumed maximum available wire supply and the minimum wire supply diameter determined by the type of spool being used is a signal that is indicative of the actual supply of wire at any given time. This signal progresses between a large diameter and the small diameter or low level when the spool is empty. These two concepts for creating a signal indicative of the actual diameter of the wire at any given time create a wire supply signal varying between a high level when the spool supply is at a presumed maximum supply of wire on the spool and a low level when the spool supply is at the minimum supply of wire on the spool. The low level is changed to correspond to the minimum diameter of the spool being monitored. A gage is used for exhibiting, at least periodically, the actual supply of wire based upon the level of the wire supply signal. The signal progresses to the empty spool reading based upon the minimum diameter of the spool.

In accordance with the present invention there is provided a monitoring device for real time sensing the actual amount of welding wire on a spool with a minimum wire supply diameter for use in a wire feeder of an electric arc welder operated at a known wire feed speed. The monitoring device comprises a device for measuring the RPM of the spool (“RPM device”) to create a spool speed signal indicative of the rotational speed of the spool as the spool provides wire at the known wire feed speed. A converting device is used for converting, according to a set relationship, the spool speed signal into a wire supply signal varying between a high level when the spool speed signal is at a low level at the time with a presumed maximum supply of wire on the spool and a low level when the spool speed signal is high at the minimum supply of wire on the spool determined by the minimum wire supply diameter. The minimum diameter determines the zero value of the wire supply signal. The wire feed speed (WFS) is divided by the rotational speed of the spool to provide a wire supply signal indicative of the diameter of the actual wire supply. This wire supply signal progresses to a low level indicating an empty spool. Thus, this preferred version of the present invention involves comparing the wire feed speed and the spool rotational speed at any given time to determine the diameter of the wire supply. When the relationship reaches the minimum diameter, the spool is empty.

In accordance with another version of the invention, the diameter of the wire supply can be measured mechanically and directly to provide a signal representative of the diameter of the wire supply. This diameter signal varies between a maximum diameter and a minimum diameter to create a wire supply signal indicative of the diameter of the supply which is related to the volume of the welding wire available on the spool. The minimum diameter determines the zero value of the wire supply signal.

In the invention, the minimum diameter of the wire supply on the spool must be known to provide the output of a gage indicative of when the wire supply is progressing toward empty. A first signal is based upon a characteristic of the actual supply of wire on the spool. This signal is non-linear between a maximum supply of wire and a minimum supply of wire. This non-linear signal can be used in a gage to show the actual supply of wire; however, in accordance with another aspect of the present invention, the device for converting the sensed signal into the output wire supply signal indicative of the wire supply involves a stage for converting a non-linear signal into a linear wire supply signal. It must be remembered that the signal indicative of the actual diameter of the wire on the spool is in the preferred embodiment a relationship between the wire feed speed and the rotational speed of the spool.

The wire on a spool is provided with a definite shape, like a donut, with a fixed internal diameter equal to the spool hub size or the minimum diameter of the supply of wire. The outside diameter of the wire on the spool is related to the amount of wire actually on the spool. In the broad aspect of the invention, use of the width of the spool (h) is not necessary, although it does determine, with the diameter of the supply, the actual volume of wire available at any given time. The wire feed speed and the spool revolution speed are proportional to the circumference of the wire supply at any given time. This relationship is used to create a signal indicative of the actual amount of wire on the spool. As the wire is consumed, the wire supply diameter and circumference decreases and the spool rotates faster. Eventually, the ratio of wire feed speed and spool rotational speed reaches a value that indicates the wire supply diameter is equal to the spool hub size or minimum supply of wire available on the spool. At this point, the wire supply is nearly consumed and the spool is empty. The supply of wire on the spool can be monitored by knowing the wire feed speed and measuring the spool speed to give the actual diameter. This is compared to the minimum diameter of the spool to give the remaining volume of wire. The remaining volume is equal to πr_{c}²h-πrₐ²h. The actual diameter minus the minimum diameter is indicative of the available wire.

The spool revolutionary speed will be a function of the actual supply of wire on the spool.

The following equation shows the relationship of the actual wire supply circumference Cₛ as it relates to the maximum circumference C_{b} and the minimum circumference Cₐ.
Cₐ=πdₐ
C_{b}=πd_{b}
Cₛ=πdₛ
WFS/RPM=Cₛ
RPM ↑ Cₛ ↓

As the circumference of the wire supply C_{s′} changes with the diameter of the supply, the status of the wire supply can be communicated to the welder for appropriate purposes. During the consumption of the wire supply from full to empty, the value of Cₛ will move from C_{b} to Cₐ. The relationship between the wire feed speed and the rotational speed of the spool creates a signal indicative of the actual circumference of the wire supply. With a known minimum diameter for any given spool, a wire supply signal is created that progresses between a presumed maximum level and a minimum level determined by the actual minimum diameter of the spool. The relationship of wire feed speed and spool rotational speed provides a wire supply signal indicative of the actual supply of wire on the spool. This signal progresses toward the minimum circumference for a given spool.

In the preferred embodiment of the invention, the real time actual wire supply diameter is determined by a signal created between the rotational speed of the spool and the wire feed speed of the wire. To determine the rotational speed of the spool, the spool is provided with an element that passes a sensing element on the welder to create pulses at a rate indicative of the rotational speed of the spool. This can be done by any mechanism, such as magnetic elements, a proximity sensor or an optical sensor. The RPM measurement system can involve an element added to the spool; however, in the preferred application of the invention, a standard spool is used. The spool mounting spindle is modified for practicing the preferred embodiment of the present invention. Thus, the rotational speed of the spool is obtained through the rotational speed of the spindle used to mount the spool onto the welder and does not require a special spool.

By using the present invention, the supply of wire on a rotating spool is monitored between full and empty. A signal from the spool is used to create a wire supply signal indicative of the actual amount of wire on the spool. This wire supply signal is then communicated to and used by several output devices. An analog meter is used to indicate wire supply from full to empty. A bar graph is used indicating the supply of wire. An audible or visual alarm is employed for indicating when the wire supply is low. In accordance with another aspect of the present invention, the welding process is stopped when the wire supply available for the next welding operation is not sufficient to complete the next weld cycle. This will eliminate damage to the contact tip and the workpiece when the supply of wire is exhausted during a welding cycle. Commencement of welding after the welder has been stopped, requires a reset routine normally done by replacing the empty spool with a full spool.

As indicated before, the broad aspect of the invention is creating a signal corresponding to the actual wire supply. This signal represents the actual supply of wire; however, it is not a linear signal over the total range. Thus, an aspect of the invention involves converting this non-linear relationship between a full spool of wire and an empty spool into a linear wire supply signal for use with various meters and gages by using the width h of the wire supply. The minimum diameter and/or the width h of the wire supply of the spool determines the low end of the signal. Spools have different minimum diameters and widths. These dimensions must be known to set the empty level of the wire supply signal. To determine the minimum diameter and width of a given spool, the spool can have a bar code label that is read by the monitoring device of the present invention. Furthermore, an optical code pattern, IR, RF devices or a touch memory button is provided on the spool. These devices contain the data to set the minimum diameter of the spool and the width of the wire supply on the spool. They are read to set the minimum level of the output signal created by the inventive monitoring device. In many instances the welder using the present invention only uses one type spool. Thus, the minimum diameter and width of the spool is always known and need not be read or set into the monitor each time the spool is emptied. In other situations, the minimum diameter and width is merely inputted manually into the monitoring device of the present invention. All of these arrangements for providing the minimum diameter and width so as to establish the point at which the wire is exhausted can be used in practicing the present invention.

Not only is the spool minimum diameter and width often fixed, the wire feed speed is normally fixed. It can be read by either the speed of the drive rolls or the speed of the motor driving the drive rolls if the gear box ratio between the motor and drive rolls is known. All of these arrangements are used to set the wire feed speed when this parameter is used to perform the invention. The system merely requires knowing the wire feed speed. It can be set or adjusted and read.

The primary object of the present invention is the provision of a device for monitoring the actual supply of welding wire on a rotating spool as the wire is being pulled by a wire feeder.

Another object of the present invention is the provision of a device, as defined above, where a real time gage is employed for determining the actual volume of welding wire on a rotating spool between a maximum level and a minimum, low level set by minimum diameter of the spool itself.

Still a further object of the present invention is the provision of a monitoring device, as defined above, which monitoring device determines the diameter of the supply of wire on a spool by either the relationship of the wire feed speed and rotational velocity of the spool or the actual sensed diameter of the supply. This non-linear relationship between the maximum level and a known minimum level constitutes a wire supply signal that is displayed by a gage, a meter or an alarm. This signal can be converted to a linear signal by using the spool width to employ volume from diameter measurements.

Still a further object of the present invention is the provision of a method of monitoring the actual supply of wire on a spool between a maximum amount and a minimum amount determined by the minimum diameter of the spool on which the welding wire is stored.

Yet another object of the present invention is the provision of a monitoring device or method, as defined above, which device or method can be easily used with an existing wire feeder and does not require visual access to the spool itself during the welding operation.

Another object of the present invention is the provision of a device or method, as defined above, which device or method creates a wire supply signal between a maximum level indicative of a full spool and a minimum or low level indicative of the minimum diameter of the spool. This wire supply signal is used in one of several types of gages or meters readable between full and empty, as these terms relate to the actual real time condition of the supply of wire. By factoring in the width of the wire supply the actual amount of wire at any given time is readable.

These and other objects and advantages will become apparent from the following description taken together with the accompanying drawings.

### BRIEF DESCRIPTION OF DRAWINGS

FIG. 1 is a block diagram showing a simplified version of the preferred embodiment of the present invention;

FIGS. 1A, 1B and 1C are pictorial representations of gages or meters operated by the output signal of the present invention to represent the amount of wire on a monitored spool;

FIG. 2 is a cross sectional view of a representative spool to be monitored by the present invention, as illustrated in FIG. 1;

FIG. 3 is a side elevational view of a spindle used for rotatably mounting the spool shown in FIG. 2 to provide welding wire to the wire feeder to illustrate another aspect of the present invention;

FIG. 4 is a graph illustrating a curve constituting the relationship between the diameter of the spool shown in FIG. 2 and the volume of wire on the spool between a minimum amount of wire at diameter a and a maximum supply of wire at a larger diameter b;

FIG. 5 is a graph showing curves representing the rotational speed of the spool shown in FIG. 2 between the maximum diameter b and minimum diameter a for different wire feed speeds, which curves are indicative of the volume of wire and generally the diameter of wire at any given time on the spool;

FIG. 5A is an enlargement of the lower portion of the graph of FIG. 5 with the terminal ends of the curves with control levels;

FIG. 5B is an enlarged view of the terminal end of one curve shown in FIG. 5;

FIG. 6 is a side elevation of the spool shown in FIG. 2 having a bar code to indicate the minimum diameter a′ of the spool and the width of the spool used in practicing the present invention;

FIG. 6A is a partial view, similar to FIG. 6, showing another element for reading the minimum supply diameter a″ and the width of the spool for use in practicing the present invention;

FIG. 7 is a block diagram and a flow chart expanding the disclosure in FIG. 1 and illustrating certain added features used in the invention;

FIG. 8 is a block diagram showing a concept for communicating information from several welders using the preferred embodiment of the present invention;

FIG. 9 is a schematic block diagram illustrating a stage used in the preferred practice of the invention for converting a non-linear signal into a linear signal for use in an output gage;

FIG. 10 is a WFS curve showing the wire feed speed often found in a welding process and illustrating an implementation of another aspect of the invention;

FIG. 11 is a curve similar to FIG. 10 illustrating a sampling concept used in the preferred embodiment of the invention;

FIG. 12 is a schematic diagram illustrating a mechanism for directly measuring the diameter of the supply of welding wire on a spool as shown in FIG. 2; and,

FIG. 13 is a block diagram showing a system for converting the signal, as shown in FIG. 4 and obtained by use of a device schematically illustrated in FIG. 12, to provide an output wire supply signal to operate a gage in accordance with a second embodiment of the present invention.

### PREFERRED EMBODIMENT

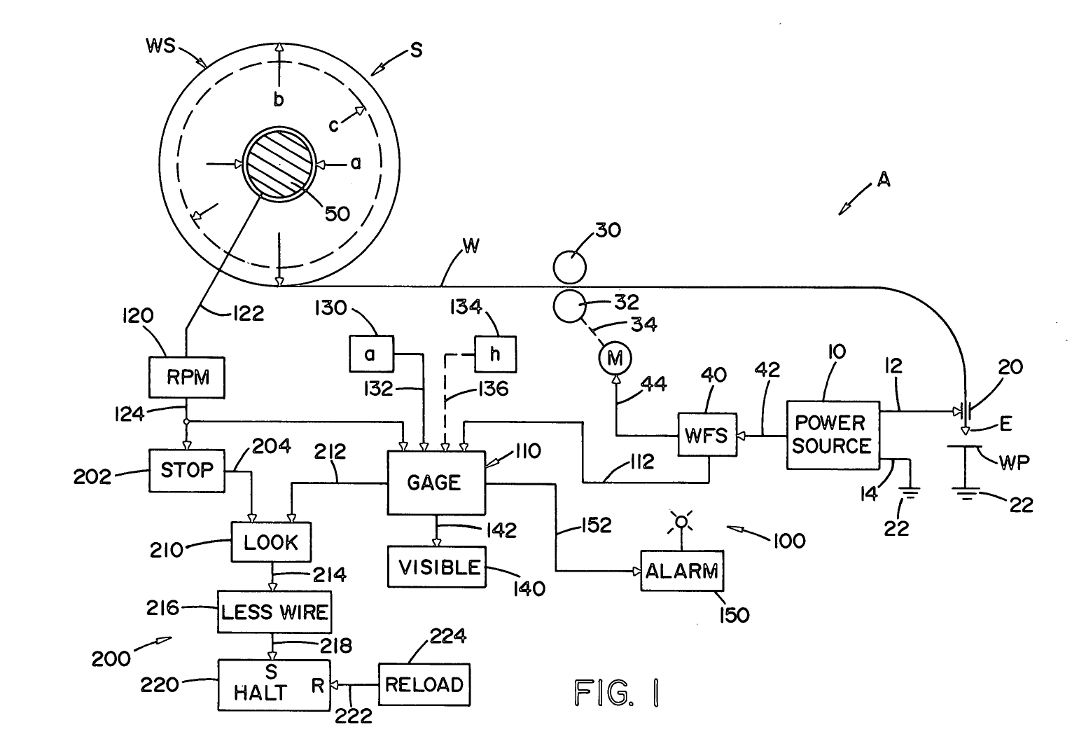

Referring now to the drawings wherein the showings are for the purpose of illustrating a preferred embodiment of the invention only and not for the purpose of limiting same, FIG. 1 illustrates schematically an electric arc welder A having a standard power source 10 with output terminals 12, 14 for the purpose of directing electrical welding current to torch 20 to pass a current between electrode E in the form of an advancing wire W and workpiece WP. Power source 10 and workpiece WP are grounded at ground 22 to perform a welding operation comprising a series of welding cycles. Each welding cycle requires a given amount of wire W provided from a standard spool S rotatably mounted on spindle 50 of the wire feeder associated with welder A. The supply of wire WS on spool S progresses from a maximum volume or a volume defined by diameter b to a minimum volume defined by diameter a. The real time or actual amount of wire on spool S is indicated by volume determined by diameter c. Of course, the diameters determine the circumferences from the maximum supply of wire to the minimum supply of wire. With the width h, the sensed measurement can be volume. At its maximum volume, wire supply WS has a circumference C_{b} which indicates the length of the wire W available during each rotation of spool S. The wire supply WS includes a minimum diameter a to reflect circumference Cₐ representing the minimum volume of the wire supply dictated by the internal diameter or circumference of spool S. Circumference Cₐ is the amount of wire available during the last rotation when the wire supply WS is exhausted. At any given time, the detected volume of wire minus the volume of the spool hub is the actual volume of welding wire. Each rotation of spool S provides a length of wire generally corresponding to circumference C_{c}. The speed of spool S is determined by a wire feeder including feed rolls 30, 32 driven by motor M through a shaft 34 normally having a gear ratio, so the speed of the motor M is greater than the rotational speed of feed rolls 30, 32. A microprocessor or controller 40 has an input 42 from the controller of power source 10 and an output 44 for controlling the speed of motor M. Thus, the rotational speed of drive rolls 30, 32 determines the rotational speed of spool S, which spool speed varies according to the circumference of the wire supply WS which progresses from diameter b to diameter a. The minimum diameter a is a characteristic of the spool being used for supplying the welding wire W. As so far described, welder A, with its wire feeder, draws wire from spool S so that the wire is provided to gun 20 at a wire feed speed determined by the signal on line 44. It is the object of the present invention to know the amount of wire at any given time, represented by diameter and circumference C_{c}, giving a volume V_{c}. Wire supply diameter c progresses from diameter b to fixed minimum diameter a. Thus, the volume V_{c} decreases from V_{b} to Vₐ. The invention relates to a manner of exhibiting the progression of diameter c as it approaches and reaches the minimum diameter a fixed by the inner core diameter of spool S.

The present invention involves monitoring device 100 having an output gage 110 to indicate the actual supply of wire on spool S as represented by diameter c as it progresses from diameter b to the fixed or minimum diameter a. In accordance with this preferred embodiment of the present invention, gage 110 uses the ratio of the wire feed signal on line 112 from wire feed speed control 40 and the rotational speed of spool S determined by RPM device 120 driven by an appropriate input 122 in the form of a pulse rate counter or other RPM measuring device. The output signal of RPM device 120 is a speed signal on line 124 having a magnitude representing the actual rotational speed of spool S. The signals or values on lines 112, 124 are mathematically combined by gage 110 into a wire supply signal representative of the actual percentage of wire on spool S. Since the volume of wire progresses from a maximum to the minimum diameter a, gage 110 is controlled by device 130 for loading the actual minimum diameter a into gage 110 by way of line 132. To have gage 110 read the actual volume of wire, the width h of the spool is directed to the gage as indicated by block 134 with output h in dashed line 136 forming an optional input to the gage. By using this input the level of the actual volume of wire is created on line 142.

The gage 110 creates a wire supply signal representing the ratio of the RPM to the wire feed speed on a generally continuous basis from a maximum circumference to a minimum circumference set by the value of the minimum diameter loaded into device 130. The signal on line 132 is used by gage 110 to determine the zero value on output line 142. Consequently, the value on line 142 progresses from a maximum wire supply value to a zero wire supply value as a percentage. If block 134 is used, actual volume is represented by the level of the signal on line 142. Thus, a non-linear percentage is outputted or width h is used to give a linear percentage or volume. Device 130 can be manually adjusted for a particular type of spool or the internal diameter a can be read from indicia on the spool or otherwise determined from the spool itself. Indeed, in most welding operations the same spool is used repeatedly; therefore, the internal diameter a is fixed so that device 130 has a fixed output. In addition the spool width h is determined in a similar manner. With the actual volume of the wire being Vₛ and the minimum volume of the wire at the center of the spool being Vₐ, the equation showing the relationship of the wire feed speed and the RPM for a spool with a thickness h is indicated by the formulae below.
Vₛ=V_{c}−Vₐ (Spool supply)
Vₐ=πrₐ²h (Volume of core)
Vₛ=πr_{c}²h−πrₐ²h
h=width of spool
C_{c}=Circumference of wire supply
RPM=WFS/C_{c}
RPM·C_{c}=WFS
C_{c}=WFS/RPM
C_{c}=2πr_{c}
2πr_{c}=WFS/RPM
r_{c}=(WFS/RPM)/2π
r_{c}=WFS/(2πRPM)
Vₛ=πh(WFS/2πRPM)²−Vₐ
∴Vₛ varies with WFS/RPM

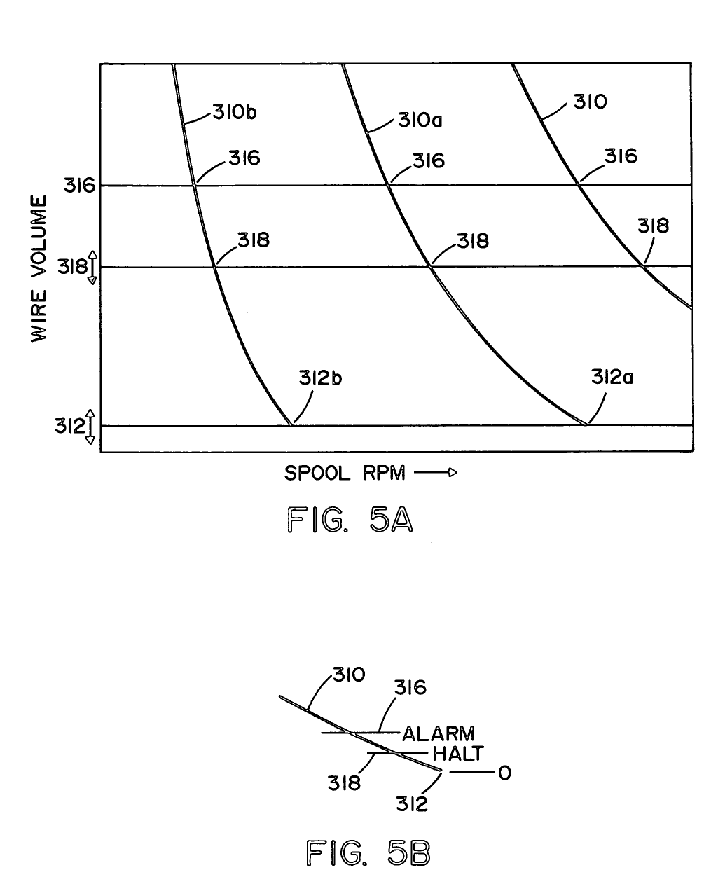

The basic concept of the preferred embodiment of the invention is sensing the variable RPM of spool S as the wire supply progresses from diameter b, circumference C_{b}, to diameter a, circumference Cₐ. Diameter a is the end of the signal progressing from diameter b to diameter a. In most instances, the wire feed speed signal on line 112 is fixed for welding operation. Thus, gage 110 essentially reads the output of RPM device 120 and uses this spool speed signal to create a wire supply signal following a curve between a maximum level representing a presumed maximum diameter b and the minimum diameter a, which is also a normally fixed parameter. Thus, gage 110 merely reads the output of RPM device 120 and produces a wire supply signal having a mathematical relationship with the spool speed signal on line 124. If only the diameter is used (the broad concept), then the signal is non-linear between full and empty. If the width h is used, the signal can be made linear if desired. Gage 110 displays a wire level controlled by the output 124 combined with signals on lines 112 and 132. The display is on visual display device 140 with a meter reading determined by output signal on line 142. The reading can be in percentage and/or volume. In a like manner, when the signal on line 124 reaches a high level indicating that the wire supply is approaching the minimum diameter a, a signal is created in alarm 150 using an output signal on line 152. As so far described, the spool speed signal on output 124 is converted by gage 110 into a wire supply signal representing the amount of wire on spool S. This output relationship is determined by the relationship indicated by the equations above and has a curve, such as one of the curves shown in FIG. 5 where several curves for different wire feed speeds are shown. This operation constitutes the preferred embodiment of the present invention. The output signals shown as curves 310, 310a and 310b in FIG. 5 are for fixed wire feed speeds (WFS) with a spool having a given internal diameter a. The output levels along curves 310, 310a and 310b of FIG. 5 are visually displayed in device 140. When the amount of wire determined by the output signal on line 124 reaches a given level approaching the low supply level at diameter a, an alarm is sounded by a signal on line 152 to activate alarm 150. This is the preferred implementation of the present invention using the relationship of the wire feed speed and the RPM of the spool to determine the diameter c of the wire supply at any given time on the rotating spool S. Monitoring device 100 normally has a fixed signal on lines 112 and a fixed signal on line 132. If volume is to be displayed, the signal on optional line 136 is also fixed. Gage 110 merely reads the output on line 124 and converts it into a wire supply signal as signals represented by curves 310, 310a and 310b illustrated in FIG. 5.

An optional feature of the invention is control device 200 shown as added to monitoring device 100 in FIG. 1. Circuit 202 creates a signal on line 204 when spool S is stopped at the end of a welding cycle. When the weld cycle stops, the stop signal on line 204 is directed to a LOOK operation routine 210 receiving a signal representing the amount of wire on line 212 from gage 110. Thus, a signal on line 214 of block 210 is the amount of wire available on spool S after completion of a welding cycle. Comparator 216 is set to the minimum amount of wire required for a welding cycle. If the amount of wire conveyed to comparator 216 is not enough for the next welding cycle as set into comparator 216, an output signal is created on line 218. This output signal activates a halt routine 220 to stop power source 10 of welder A. Thus, at the end of each welding cycle, if there is not enough wire to perform the next welding cycle, the halt routine 220 is set. Routine 220 blocks the operation of the welder until the halt routine receives a reset signal on line 222 as normally provided by a reload of a full spool S as indicated by block 224. This optional feature of the present invention uses the output of gage 110 to assure that the next welding cycle has sufficient welding wire for a complete weld cycle. Monitoring device 100 and control device 200 are normally provided in a digital format; however, analog or combined analog and digital construction of devices 100, 200 is contemplated.

Visual display 140 can take a variety of forms, such as a digital read out device 140a as shown in FIG. 1A. A fuel gage type display is shown as 140b in FIG. 1B. In a like manner, a bar graph 140c progresses from a “full” condition to an “empty” condition from right to left as shown in FIG. 1C. Other types of visual read outs can visually display the supply of welding wire on spool S in percentage, amount or general wire supply level as determined by the magnitude of the spool speed signal on line 124 used to create the wire supply signal like a signal represented by one of the curves 310, 310a or 310b shown in FIG. 5.

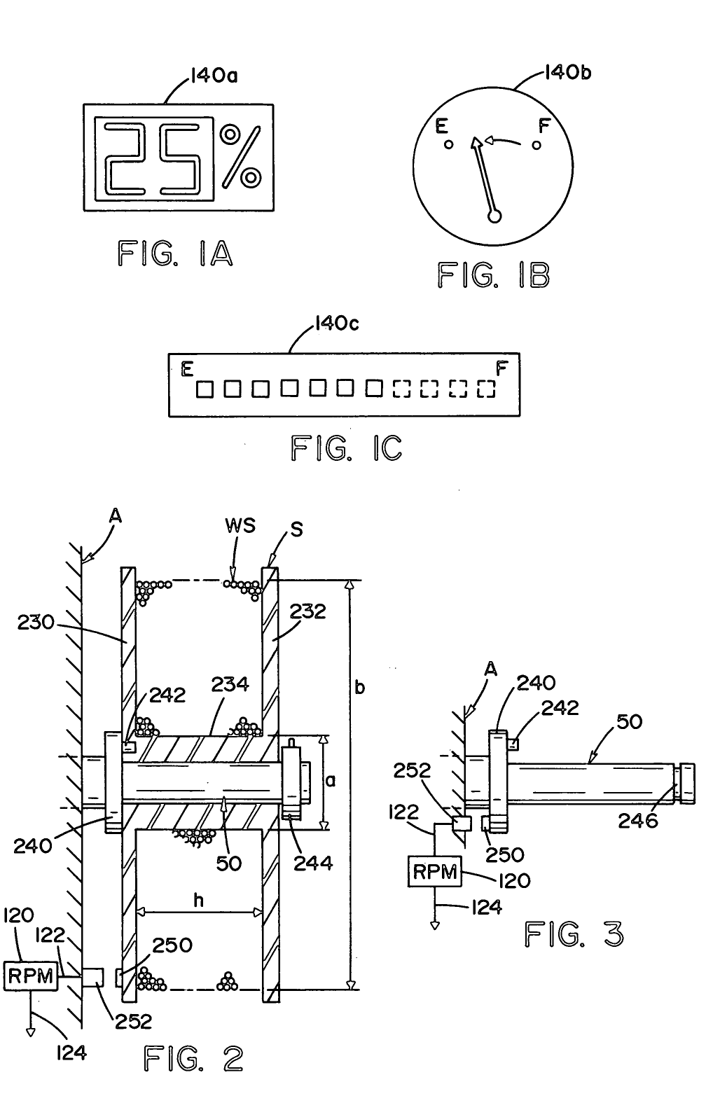

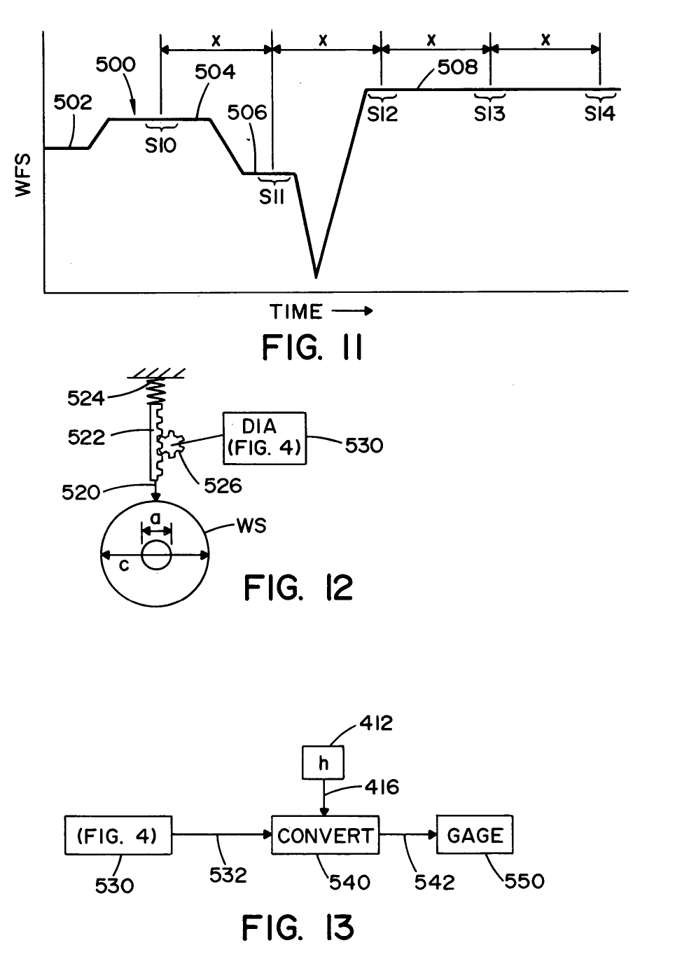

FIGS. 2 and 3 show mechanisms for creating the spool speed signal on line 124 by RPM device 120. In FIG. 2, spool S includes spaced sides 230, 232 defining the thickness h of the wire supply volume. Since the preferred embodiment of the invention and the alternative embodiment of the invention shown in FIGS. 12 and 13, in their broadest sense, function based upon the diameter of the wire supply WS, the width h is not an essential controlling dimension. However, to obtain linearity, the width of the wire supply is a value needed to read and display the actual volume at different diameters. The wire supply signal created by gage 110 is a signal indicative of the progressively reduction of the wire supply WS. Core 234 of spool S determines the minimum diameter a introduced by device 130 to determine the signal created by gage 110. Rotating spindle 50 is shown as having flange 240, a drive pin 242, an outer lock ring 244 fitting into groove 246. To determine the rotational speed of spool S, element 250, such as a magnetic element, optical elements or other readable device, is mounted on side 230 to rotate with spool S. As element 250 rotates, it passes receiving or pick-up element 252 on welder A to produce an input signal on line 122 to RPM device 120. In this manner, device 120 senses the real time rotational speed of spool S. Of course, a series of elements 250 could be spaced in a circle around side 230. By having the RPM device actuated by an element on the spool, each spool used by welder A must have a special design including the rotating element. In the preferred implementation, rotating element 250 is provided on flange 240 of spindle 50, as shown in FIG. 3. In this manner, pick-up element 252 is essentially the same as shown in FIG. 2; however, the spool S needs no special design. The only requirement is that the internal diameter a of the spool being used in the embodiment shown in FIG. 1, has a fixed known measurement. As indicated before most spools used on a given welder have the same spool design. Thus, the minimum diameter a is fixed. Furthermore, generally the wire feed speed (WFS) is fixed during a welding cycle. Consequently, RPM device 120 creates a signal on line 124 so this signal can be directly readable as indicating in an inverse function of the amount of wire actually remaining on spool S. This signal is converted into the wire supply signal, such as curves 310, 310a and 310b shown in FIG. 5.

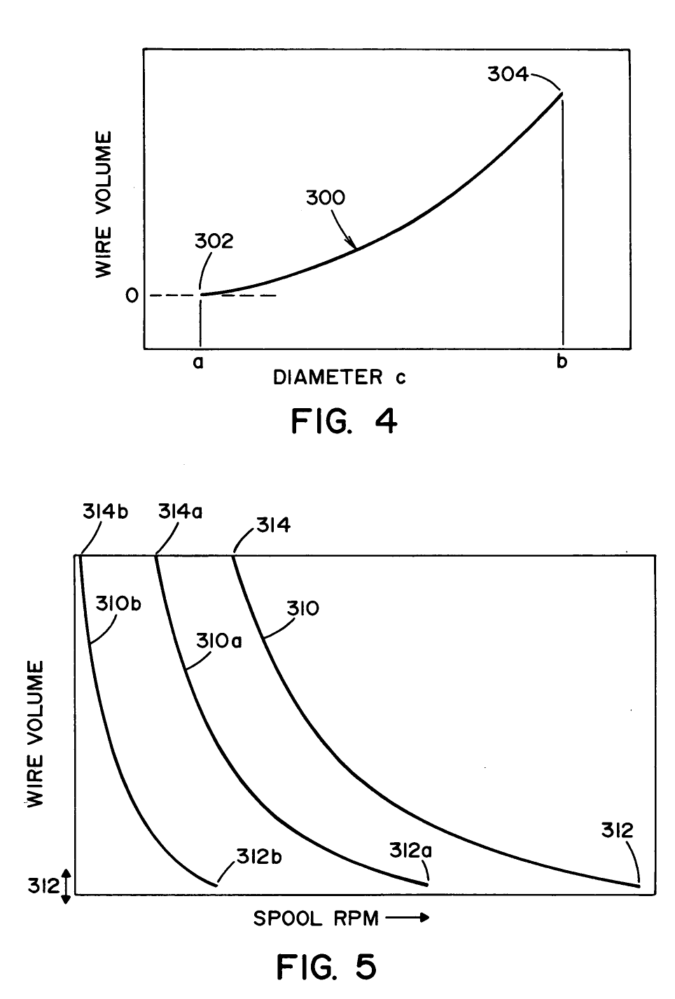

In FIG. 4, curve 300 is a wire supply signal controlled by the diameter of wire supply WS as it progresses from the outer diameter b to the inner diameter a. This relationship between wire volume and spool diameter is not linear and has a slight curve as shown in FIG. 4. The abscissa is essentially the gage value. The wire supply signal at curve 300 progresses between point 304 and 302 as the wire is used. This curve is not linear. As will be explained later, a slight non-linearity of curve 300 is corrected so that gages 110 read in a linear scale; however, this is not essential to the implementation of the present invention. Curve 300 can be used to create the wire supply signal outputted by gage 110 on line 142 and can be used to create a signal on line 152 and line 212. Curve 300 is really the broadest aspect of the invention. A signal like curve 300 indicates of the actual diameter c and is used to create the wire supply signal. Signal or curve 300 is created by merely sensing the actual diameter of the wire supply by using a system shown generally in FIGS. 12 and 13 or by simply the relationship where WFS/RPM is equal to Cₛ. In both of these non-linear functions, spool width h is not used. Consequently, the output of gage 110 does not have any units, but will merely move the meters from full to empty or from 100% to 0%. The meters will show Cₛ or c as a non-linear display.

The preferred embodiment of the invention, using the output of RPM device 120 which is combined with the WFS to create a wire supply signal as represented by curve 310, curve 310a or curve 310b shown in FIG. 5. This non-linear curve advances from points 314, 314a or 314b at diameter b to point 312, 312a or 312b at diameter a. Curve 310 is for a first wire feed speed, such as 450 ipm. A second fixed wire feed speed, such as 300 ipm created curve 310a. In a like manner, a third wire feed speed, such as 150 ipm created curve 310b. In FIG. 5A, the “empty” ends of curves 310, 310a and 310b are enlarged to show operation of alarm 150 and control device 200 shown in FIG. 1. The “empty” end of representative curve 310 is illustrated in FIG. 5B to explain actions caused by reduction of the wire supply adjacent the end of the wire supply. As diameter a of the spool is changed, point 312 of curve 310 is changed. The value of point 312 is adjusted by the diameter a so curve 310 progresses from a maximum value at point 314 determined by diameter b to the adjusted point 312 set by the internal diameter of spool S. Points 314, 314a and 314b can be adjusted for different volumes of wire when the spool is full.

The wire supply signals of curves 310, 310a and 310b are essentially the reciprocal of curve 300 in that the diameter curve 300 decreases from the maximum to the minimum level set by diameter a. Curve 300 is an algebraic “direct” relationship of wire diameter. The wire feed speed (WFS) is not a factor in the wire supply signal of curve 300. However, when using device 120, the wire feed speed must be known. The wire supply signal shown as curves 310, 310a and 310b varies according to the selected wire feed speed. Curves 310, 310a and 310b decrease from a high level to a low level. As shown in FIG. 5B, the terminal end 312 of curve 310 is adjusted by the minium diameter of the spool. When the diameter c of the wire on spool S reaches a decreased level 316, a signal appears on line 152. Alarm device 150 is actuated. Halt level 318 is determined by the amount of wire remaining on spool S to complete the next welding cycle. When gage 110 progresses to a level below value 318 and the welder is stopped at the end of a welding cycle, the welder is halted by routine 220, as shown in FIG. 1. Curves 300 of FIG. 4 and curves 310, 310a and 310b shown in FIG. 5 represent the output signals, or wire supply signals, of gage 110 using diameter sensor or spool feed speed for curve 300 or merely the spool speed signal for curves 310, 310a and 310b. Minimum diameter a of a spool being monitored determines the end points of curves 300, 310, 310a and 310b representing signals outputted by gage 110.

The diameter or radius of curve 300 in FIG. 4 can be obtained by direct measurement or by using the fact that WFS/RPM equals circumference Cₛ of the actual wire supply remaining on spools. This non-linear signal can be used in any meter or device driven by gage 110. The meters can be non-linear percentage gages or devices or linear percentage or volume gages or devices. The non-linear operation is shown in FIGS. 4 and 5. If a linear output for gage 110 is desired, the volume of the remaining wire needs to be calculated using the spool width h. The center volume of the spool Vₐ is subtracted from the wire supply measurement V_{c} to obtain the actual wire supply volume. Width h is introduced into gage 110 by device 134 shown in FIG. 1. The curve 300 of FIG. 4 is still a correct relationship, but it is modified by the use of width h. This is also true of the non-linear curves 310, 310a and 310b of FIG. 5. The non-linear curves are modified by factoring in width h and thus converting the non-linear curves to linear output curves for gage 110.

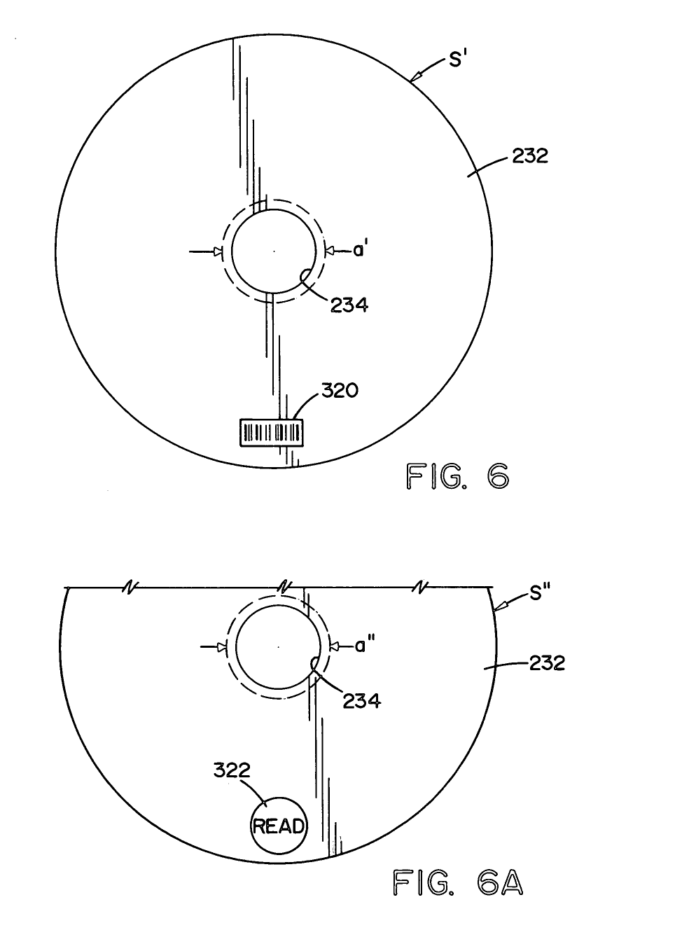

In accordance with an aspect of the invention, spool S includes information indicative of minimum diameter a of the wire supply and the width h of the spool. Several arrangements are used for identifying the internal or minimum diameter of the spool and its width. Representative concepts are illustrated in FIGS. 6 and 6A wherein side 232 includes a bar code 320 having stored data indicating the minimum diameter of the wire on spool S′ is a′ and its width h, when required. This is illustrated by a dashed line concentric with core 234. Thus, if several spools are used in welder A, device 130 has mechanism for reading bar code 320. This sets the magnitude of the signal on line 132 to indicate a minimum diameter a′ and, if needed, width h. In a like manner, a touch memory device 322 is used on spool S″. Data on this readable device is coded to indicate the minimum diameter for wire on spool S″ is a″ and its width. Thus, device 130 is used to create a signal on line 132 indicative of diameter a″ for use by gage 110 and a signal on line 136 indicative of spool width h. Other arrangements can be employed for manually reading the minimum diameter of a specific spool and its width. Furthermore, the minimum diameter and width can be read from the spool or from information associated with the spool. Irrespective of the procedure employed, a minimum diameter is set to adjust the end or “empty” points 302, 312, 312a, 312b of curve 300, and curves 310, 310a, 310b, respectively.

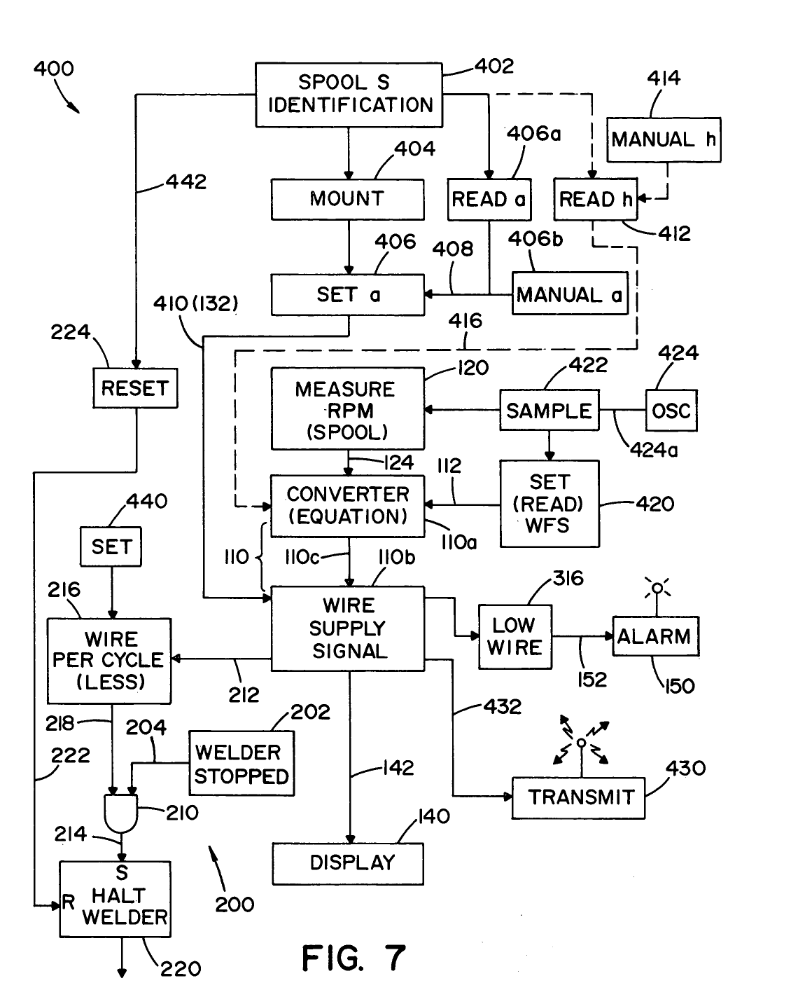

A more detailed program 400 to perform the invention is shown in FIG. 7 where components from the block diagram of FIG. 1 are combined with additional components to explain in more detail certain aspects of the invention. Program 400 can be performed by analog or digital circuits. Preferably, the primary circuit implementation is by a computer program or microprocessor software. To initiate the monitoring process, a particular spool S is identified as indicated by block 402. Spool S is mounted into the wire feeder of welder A as represented by block 404. Then, the minimum diameter a is set as indicated by block 406. This parameter is obtained by various procedures, such as reading the minimum diameter information from a coded message either on the spool or from an item associated with the spool, as indicated by block 406a. This block, or a manual setting operation indicated by block 406b, creates a signal on line 408 to set the minimum diameter a of the spool S being used by welder A. This process or procedure creates a digital data or signal on line 410 generally corresponding to line 132 of FIG. 1. This information is directed to the gage device 110 shown as being divided into a first stage 110a for converting the input signals from lines 112, 124 in accordance with a desired formula to create a signal represented by curve 300 or curves 310, 310a and 310b as shown in FIGS. 4 and 5, respectively. If the conversion of the output curves involves production of linear meter signals, the spool identification at block 402 reads the width h of spool S as represented by block 412. This width value can be manually set by an operator as shown by block 414. Thus, the value of h is communicated to stage 110a of gage, routine or program 110a. In this manner, the meter signal in line 142 is mathematically or algebraically made linear by converting the signal of FIG. 4 or the signals of FIG. 5. Stage 110b processes the signal (non-linear or linear) as the “wire supply signal.” Stages 110a, 110b are interconnected by data communication line 110c. Stage 110a performs a mathematical conversion utilizing the wire feed speed signal on line 124 and uses the value of width h to render the signal linear. Stage 110b then produces the actual wire supply signal with an end point set by minimum diameter a. As previously explained, device 120 produces the RPM or spool speed signal on line 124 directed to stage 110a. Wire feed speed (WFS) is normally fixed to provide a fixed digital signal on line 112. The signal on line 112 is set or read as indicated by block 420. In the preferred embodiment, WFS signals from block 420 and RPM signal from device 120 are sampled, as indicated by block 422 at a rate determined by the output of oscillator 424 on line 424a. Thus, periodically data on line 124 and the data on line 112 are inputted to convertor stage 110a and processed by stages 110a and 110b. This procedure creates the actual wire supply signal, shown as curves 310, 310a and 310b in FIG. 5. This signal is displayed in device 140 and activates alarm 150 when the level of the signal decreases to point 316 as shown in FIG. 5B.

A further feature of the invention is the use of transmitter 430 that receives the wire supply signal on line 432 and transmits this signal to a remote location. Program 400 produces a wire supply signal such as curves 310, 310a and 310b in FIG. 5. It utilizes converter stage 110a and signal creating stage 110b. The preferred embodiment is implemented by program 400. As explained in FIG. 1, an optional feature is provision of a control device 200. This device is illustrated in general in the left portion of program 400. Control device 200 is operated by the signal on line 212 representing the actual remaining wire on spool S. This is the current wire supply signal. Block 216 is set to a desired signal level, as indicated by block 440 to create a signal on line 218 if the magnitude of the wire supply signal has a level indicating less wire than needed to complete the next welding cycle. Gate 210 creates a signal on line 214 to set the halt routine 220 for welder W when the welder is stopped with an insufficient amount of wire on the spool. When a new spool S is loaded and identified as indicated by block 402, a signal is created on line 442 to reset a routine 220 by a reset signal on line 222. The general program described in FIG. 7 is used in combination with the preferred embodiment as illustrated in FIG. 1 in practical implementation of the present invention. Other arrangements, both analog and digital, can be used in practicing the invention as described in FIGS. 1-7.

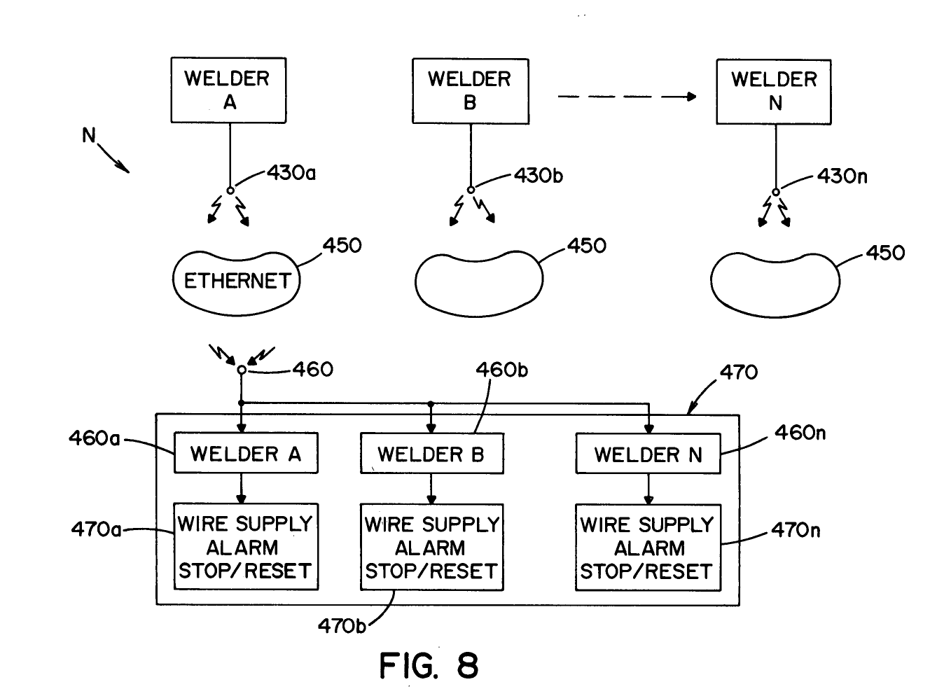

By using the present invention on several welders in a factory, it is possible to monitor the actual supply of welding wire on each of the welders at a remote location using the transmitter 430 shown in FIG. 7. A network N uses the present invention as shown schematically in FIG. 8. Welder A, welder B and other welders N have transmitters 430a, 430b and 430n, respectively. These transmitters are directed to a network indicated as ethernet 450. This network can also be telephone lines or radio transmission channels. The information from transmitters 430a, 430b and 430n are received by a single antenna or input connection 460 of console 470. Transmitters 430 each have different coded frequencies or digital codes identifying the particular welder originating the wire supply signal. Thus, the wire supply information from all welders is received by antenna 460 and is directed to decoders 460a, 460b and 460n so the wire supply signal from each of the welders is transmitted to the individual dedicated panels 470a, 470b and 470n. In this manner, each of the panels includes a display device 140 and an alarm 150 for each welder being monitored. Consequently, the alarm or display devices shown in FIG. 7 are directly connected or can be remotely located without changing the operation of the invention.

As previously discussed, the wire supply signal, either analog or digital, from stage 110b of gage 110, as shown in FIG. 7, has a form similar to curves 310, 310a and 310b shown in FIG. 5. In accordance with the preferred embodiment of the invention, this non-linear curve is converted into a linear signal, either digital or analog, by employing a third stage 110e where width h from block 412 is used for the conversion which can also be performed in stage 110a. The output signals 142, 152 and 432 are linear signals so that the gages shown in FIGS. 1A, 1B and 1C operate in a linear fashion, as opposed to non-linear. This feature of monitoring device 100 is illustrated in FIG. 9. The non-linear curves created by using the present invention are normally satisfactory for a spool wire supply meter; however, in some instances it is preferred to create a linear output signal for use in practicing the invention. This added feature using width h is disclosed and described in FIG. 9 for use with the preferred embodiment of the invention.

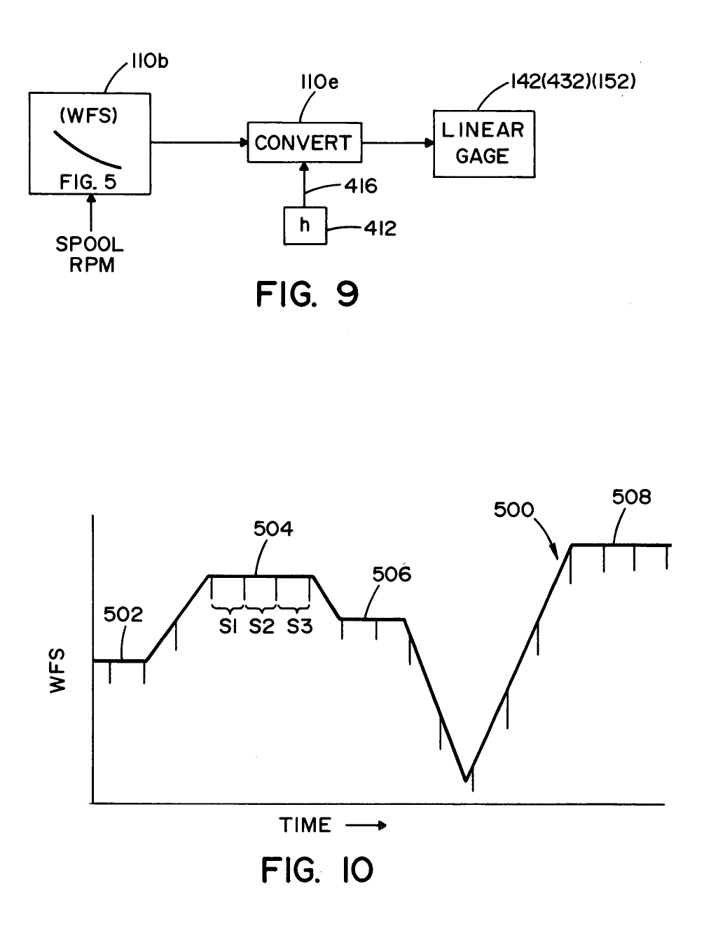

As indicated in FIG. 7 the preferred embodiment of the present invention employs a sampling routine represented by block 422. The sampling routine is operated at a frequency determined by oscillator 424. Thus, the wire feed speed and RPM of the spool are sampled periodically to create the wire supply signal at the output of gage 110. Features of the sampling technique are disclosed generally in FIGS. 10 and 11 wherein the wire feed speed curve 500 varies especially at the start of a welding cycle. At the start of a cycle, the wire feed speeds differ at sections 502, 504 and 506. The final weld cycle WFS is section 508 of curve 500. The present invention compensates for different wire feed speeds at different times in the welding cycle or during continuous operation of welder A. As the wire feed speed is reduced, the output of RPM device 120 changes accordingly. Consequently, the invention is implemented by reading the wire feed speed as indicated by block 420 in FIG. 7. In the preferred implementation of the present invention, the wire feed speed normally varies only at the start of the welding cycle as shown in sections 502, 504 and 506. After the welding has started, the wire feed speed is fixed by control 40 and has a constant value shown as section 508. Thus, it is within the scope of the invention to operate monitoring device 100 only after a predetermined time following the start of the welding cycle. Thereafter, the wire feed speed is constant and the signal on line 112 remains fixed for combination with the fixed signal on line 132. In this manner, the output of gage 110 is controlled by the digital or analog signal on line 124 with the other parameters fixed. In FIG. 10, the sampling rate is quite rapid so that samples S1, S2 and S3 occur in sequence. This sampling procedure is performed throughout curve 500. In the preferred embodiment, the sampling states are spaced by time of less than about 100 ms. This is shown in FIG. 11 wherein the spacing x of the samples S10-S14 is a fixed distance determined by the frequency of oscillator 424. In summary, samples can be performed periodically, but in groups as shown in FIG. 10 or samples can be performed periodically in spaced locations as shown in FIG. 11. The later sampling technique is preferably used for digital operation of program 400. Of course, analog operation is possible with a continuous analog signal on line 124 with a fixed analog signal on line 112. All of these modifications can be used without really departing from the basic concept of monitoring the real time supply of welding wire and displaying the magnitude of this supply on a scale representing the percentage of welding wire actually remaining at any given time.

As described earlier, the present invention uses the spool feed speed from RPM device 120 in combination with the feed speed (WFS) to create a wire supply signal represented by curves 310, 310a and 310b shown in FIG. 5. Non-linear curve 300 of FIG. 4 can also be obtained by using this concept. However, in a broad sense, it is also possible to provide a signal directly from spool S to create non-linear curve 300 as shown in FIG. 4. Curve 300 decreases as the diameter of the wire supply WS decreases from diameter b to diameter a. This represents a simple implementation of the present invention and is schematically shown in FIGS. 12 and 13. A wire supply WS has a diameter c decreasing toward a minimum diameter a. To measure the actual diameter, feeler 520 carried by rack 522 is biased downwardly against the wire supply WS by spring 524. Pinion 526 is rotated by rack 522 to create a signal by use of device 530. This is a wire supply signal having the characteristics of curve 300 in FIG. 4. A signal having the shape of curve 300 is then used in the invention to drive visual display 140, alarm 150 and/or transmitter 430, as previously described. This embodiment of the present invention is not preferred because of the difficulty in actually sensing the diameter of the spool. However, FIGS. 12 and 13 illustrate the broad nature of the invention. As illustrated in FIG. 13, the output of device 530 is not affected by the wire feed speed. It merely records the diameter c of the wire supply. Such reading creates the non-linear signal as shown in FIG. 4 on output line 532 of device 530. This non-linear signal is useful in practicing the invention. The non-linear signal on line 532 is converted by circuit or program 540 by using width h from block 412 to produce a linear signal representing the diameter c of spools between the maximum diameter b and minimum diameter a. The linear signal on line 542 drives gage 550 for use in display device 140, alarm 150 and transmitter 430 as shown in FIG. 7.

The present invention is a monitoring device for creating a first signal indicative of the actual diameter of the wire at any given time, a converter for converting the first signal into a wire supply signal varying between a high level when the spool supply is at a presumed maximum supply of wire on the spool and a low level when the spool supply is at the minimum supply of wire on the spool and a gage for exhibiting, at least periodically, the actual amount of wire based upon the magnitude of the wire supply signal. The actual diameter c is determined by the relationship between the rotational speed of the spool and the wire feed speed of the wire feeder in the preferred embodiment of the implementation as shown in FIGS. 1-7. However, the first signal can involve a direct reading of diameter c of the supply of wire WS on the spool, as illustrated in FIGS. 12-13. This produces a wire supply signal 300 as shown in FIG. 4. Various other uses and modifications of the embodiments of the invention can be made without departing from the intended spirit and scope of the invention as defined in the appended claims.

Having thus defined the invention, the following is claimed:

1. A monitoring device for sensing of the actual amount of welding wire on a spool with a minimum wire supply diameter for use in a wire feeder of an electric arc welder operated at a known wire feed speed, said monitoring device comprising: an RPM device to create a spool speed signal indicative of the rotational speed of said spool as said spool provides wire at said known wire feed speed and a converting device for converting, according to a set relationship, said spool speed signal into a wire supply signal varying between a high level when said spool speed signal is low at a presumed maximum supply of wire on said spool and a low level when said spool speed signal is high at the minimum supply of wire on said spool determined by said minimum wire supply diameter.

2. A monitoring device as defined in claim 1 wherein said spool includes a wire supply width and said converting device includes a stage for converting said spool speed signal into a linear wire supply signal by using said wire supply width.

3. A monitoring device as defined in claim 2 including a display unit to display the level of said wire supply signal.

4. A monitoring device as defined in claim 3 wherein said display unit is an analog gage.

5. A monitoring device as defined in claim 3 wherein said display unit is a digital gage.

6. A monitoring device as defined in claim 1 including a display unit to display the level of said wire supply signal.

7. A monitoring device as defined in claim 6 wherein said display unit is an analog gage.

8. A monitoring device as defined in claim 6 wherein said display unit is a digital gage.

9. A monitoring device as defined in claim 6 including an alarm unit responsive to said wire supply signal decreasing to a set value near said low level.

10. A monitoring device as defined in claim 9 wherein said alarm unit produces an audible alarm.

11. A monitoring device as defined in claim 3 including an alarm unit responsive to said wire supply signal decreasing to a set value near said low level.

12. A monitoring device as defined in claim 11 wherein said alarm unit produces an audible alarm.

13. A monitoring device as defined in claim 2 including an alarm unit responsive to said wire supply signal decreasing to a set value near said low level.

14. A monitoring device as defined in claim 13 wherein said alarm unit produces an audible alarm.

15. A monitoring device as defined in claim 1 including an alarm unit responsive to said wire supply signal decreasing to a set value near said low level.

16. A monitoring device as defined in claim 15 wherein said alarm unit produces an audible alarm.

17. A monitoring device as defined in claim 6 including a device to prevent operation of said welder when said wire supply signal level is below a given amount.

18. A monitoring device as defined in claim 17 including a device for adjusting said given amount.

19. A monitoring device as defined in claim 18 wherein said adjusted given amount is generally related to the amount of wire used for a welding cycle of said welder.

20. A monitoring device as defined in claim 3 including a device to prevent operation of said welder when said wire supply signal level is below a given amount.

21. A monitoring device as defined in claim 20 including a device for adjusting said given amount.

22. A monitoring device as defined in claim 21 wherein said adjusted given amount is generally related to the amount of wire used for a welding cycle of said welder.

23. A monitoring device as defined in claim 2 including a device to prevent operation of said welder when said wire supply signal level is below a given amount.

24. A monitoring device as defined in claim 23 including a device for adjusting said given amount.

25. A monitoring device as defined in claim 24 wherein said adjusted given amount is generally related to the amount of wire used for a welding cycle of said welder.

26. A monitoring device as defined in claim 1 including a device to prevent operation of said welder when said wire supply signal level is below a given amount.

27. A monitoring device as defined in claim 26 including a device for adjusting said given amount.

28. A monitoring device as defined in claim 27 wherein said adjusted given amount is generally related to the amount of wire used for a welding cycle of said welder.

29. A monitoring device as defined in claim 26 including an adjust circuit responsive to a diameter signal for changing said low level upon changing said known minimum wire supply diameter.

30. A monitoring device as defined in claim 29 including a readable code element on said spool indicative of a known minimum wire supply diameter and a reader to read said code element and create a diameter transmitted to said adjust circuit.

31. A monitoring device as defined in claim 6 including an adjust circuit responsive to a diameter signal for changing said low level upon changing said known minimum wire supply diameter.

32. A monitoring device as defined in claim 31 including a readable code element on said spool indicative of a known minimum wire supply diameter and a reader to read said code element and create a diameter transmitted to said adjust circuit.

33. A monitoring device as defined in claim 3 including an adjust circuit responsive to a diameter signal for changing said low level upon changing said known minimum wire supply diameter.

34. A monitoring device as defined in claim 33 including a readable code element on said spool indicative of a known minimum wire supply diameter and a reader to read said code element and create a diameter transmitted to said adjust circuit.

35. A monitoring device as defined in claim 2 including an adjust circuit responsive to a diameter signal for changing said low level upon changing said known minimum wire supply diameter.

36. A monitoring device as defined in claim 35 including a readable code element on said spool indicative of a known minimum wire supply diameter and a reader to read said code element and create a diameter transmitted to said adjust circuit.

37. A monitoring device as defined in claim 1 including an adjust circuit responsive to a diameter signal for changing said low level upon changing said known minimum wire supply diameter.

38. A monitoring device as defined in claim 37 including a readable code element on said spool indicative of a known minimum wire supply diameter and a reader to read said code element and create a diameter transmitted to said adjust circuit.

39. A monitoring device as defined in claim 26 wherein said RPM device comprises a readable element on said spool and a sensing element on said welder at a location passed by said readable element on each rotation of said spool.

40. A monitoring device as defined in claim 6 wherein said RPM device comprises a readable element on said spool and a sensing element on said welder at a location passed by said readable element on each rotation of said spool.

41. A monitoring device as defined in claim 3 wherein said RPM device comprises a readable element on said spool and a sensing element on said welder at a location passed by said readable element on each rotation of said spool.

42. A monitoring device as defined in claim 2 wherein said RPM device comprises a readable element on said spool and a sensing element on said welder at a location passed by said readable element on each rotation of said spool.

43. A monitoring device as defined in claim 1 wherein said RPM device comprises a readable element on said spool and a sensing element on said welder at a location passed by said readable element on each rotation of said spool.

44. A monitoring device as defined in claim 26 wherein said welder includes a rotatable spindle for carrying and rotating with said spool and wherein said RPM device comprises a readable element on said spindle and a sensing element on said welder at a location passed by said readable element on each rotation of said spindle.

45. A monitoring device as defined in claim 6 wherein said welder includes a rotatable spindle for carrying and rotating with said spool and wherein said RPM device comprises a readable element on said spindle and a sensing element on said welder at a location passed by said readable element on each rotation of said spindle.

46. A monitoring device as defined in claim 3 wherein said welder includes a rotatable spindle for carrying and rotating with said spool and wherein said RPM device comprises a readable element on said spindle and a sensing element on said welder at a location passed by said readable element on each rotation of said spindle.

47. A monitoring device as defined in claim 2 wherein said welder includes a rotatable spindle for carrying and rotating with said spool and wherein said RPM device comprises a readable element on said spindle and a sensing element on said welder at a location passed by said readable element on each rotation of said spindle.

48. A monitoring device as defined in claim 1 wherein said welder includes a rotatable spindle for carrying and rotating with said spool and wherein said RPM device comprises a readable element on said spindle and a sensing element on said welder at a location passed by said readable element on each rotation of said spindle.

49. A monitoring device as defined in claim 37 including a transmitting device for transmitting said wire supply signal to a remote location.

50. A monitoring device as defined in claim 26 including a transmitting device for transmitting said wire supply signal to a remote location.

51. A monitoring device as defined in claim 6 including a transmitting device for transmitting said wire supply signal to a remote location.

52. A monitoring device as defined in claim 3 including a transmitting device for transmitting said wire supply signal to a remote location.

53. A monitoring device as defined in claim 2 including a transmitting device for transmitting said wire supply signal to a remote location.

54. A monitoring device as defined in claim 1 including a transmitting device for transmitting said wire supply signal to a remote location.

55. A monitoring device as defined in claim 37 wherein said converting device makes said conversion at closely spaced sampling times.

56. A monitoring device as defined in claim 55 wherein sampling times are spaced at least about 100 ms.

57. A monitoring device as defined in claim 26 wherein said converting device makes said conversion at closely spaced sampling times.

58. A monitoring device as defined in claim 57 wherein sampling times are spaced at least about 100 ms.

59. A monitoring device as defined in claim 6 wherein said converting device makes said conversion at closely spaced sampling times.

60. A monitoring device as defined in claim 59 wherein sampling times are spaced at least about 100 ms.

61. A monitoring device as defined in claim 3 wherein said converting device makes said conversion at closely spaced sampling times.

62. A monitoring device as defined in claim 61 wherein sampling times are spaced at least about 100 ms.

63. A monitoring device as defined in claim 2 wherein said converting device makes said conversion at closely spaced sampling times.

64. A monitoring device as defined in claim 63 wherein sampling times are spaced at least about 100 ms.

65. A monitoring device as defined in claim 1 wherein said converting device makes said conversion at closely spaced sampling times.

66. A monitoring device as defined in claim 65 wherein sampling times are spaced at least about 100 ms.

67. A monitoring device for sensing of the actual amount of wire on a spool with a minimum wire supply diameter for use in a wire feeder of an electric arc welder, said monitoring device comprising: a diameter device to create a diameter signal indicative of the diameter of said wire on said spool as said spool provides wire for welding and a converting device for converting said diameter signal into a wire supply signal varying between a high level when said diameter signal is high at a presumed maximum supply of wire on said spool and a low level when said diameter signal is low at the minimum supply of wire on said spool determined by said minimum diameter.

68. A monitoring device as defined in claim 67 wherein said spool includes a wire supply width and said converting device includes a stage for converting said diameter signal into a linear wire supply signal by using said wire supply width.

69. A monitoring device as defined in claim 67 including a display unit to display the level of said wire supply signal.

70. A monitoring device as defined in claim 69 wherein said display unit is an analog gage.

71. A monitoring device as defined in claim 69 wherein said display unit is a digital gage.

72. A monitoring device as defined in claim 67 including an alarm unit responsive to said wire supply level decreasing to a set value near said low level.

73. A monitoring device as defined in claim 72 wherein said alarm unit produces an audible alarm.

74. A monitoring device as defined in claim 67 including a device to prevent operation of said welder when said wire supply signal level is below a given amount.

75. A monitoring device as defined in claim 74 including a device for adjusting said given amount.

76. A monitoring device as defined in claim 67 including an adjust circuit responsive to a diameter signal for changing said low level upon changing said known minimum wire supply diameter.

77. A monitoring device as defined in claim 67 wherein said RPM device comprises a readable element on said spool and a sensing element on said welder at a location passed by said readable element on each rotation of said spool.

78. A monitoring device as defined in claim 67 wherein said welder includes a rotatable spindle for carrying and rotating with said spool and wherein said RPM device comprises a readable element on said spindle and a sensing element on said welder at a location passed by said readable element on each rotation of said spindle.

79. A monitoring device as defined in claim 67 including a transmitting device for transmitting said wire supply signal to a remote location.

80. A monitoring device as defined in claim 67 wherein said converting device makes said conversion at closely spaced sampling times.

81. A monitoring device as defined in claim 80 wherein sampling times are spaced at least about 100 ms.

82. A method of monitoring the actual amount of welding wire on a spool with a minimum wire supply diameter for use in a wire feeder of an electric arc welder, said method comprising:
(a) pulling said wire from said spool at a known wire feed speed;
(b) creating a spool speed signal indicative of the rotation of speed of said spool;
(c) converting said spool speed signal into a wire supply signal having a given relationship to said spool speed signal; and,
(d) displaying said wire supply signal as the remaining wire on said spool between a high level and a low level determined by said minimum diameter.

83. A method as defined in claim 82 further including:
(e) using a non-linear to linear equation in said conversion of signals.

84. A method as defined in claim 82 further including:
(e) creating an alarm signal when said wire supply signal decreases to a set value above said low level but near the end of said welding wire.

85. A method as defined in claim 82 further including:
(e) preventing operation of said welder when said wire supply signal is below a given level.

86. A method as defined in claim 82 further including:
(e) changing said known wire feed speed.

87. A method as defined in claim 82 further including:
(e) changing said known minimum wire supply diameter; and,
(f) changing said low level according to said changed minimum wire supply diameter.

88. A device for controlling a welder using a given amount of wire for a weld cycle, said device comprises: a device to determine the remaining amount of wire on the wire supply used by the welder; a device for creating a halt signal when said amount of wire is less than said given amount; and, a device to prevent operation of said welder upon creation of said halt signal.

89. A method for controlling a welder using a given amount of wire for a weld cycle, said method comprises:
(a) determining the remaining amount of wire on the wire supply used by the welder;
(b) creating a halt signal when said amount of wire is less than said given amount; and,
(c) preventing operation of said welder upon creation of said halt signal until more wire is provided.

90. A method of monitoring the amount of wire on several electric arc welders operating at the same time, said method comprising:
(a) determining the real time amount of welding wire on each of several electric arc welders;
(b) transmitting signals representative of the real time amounts of wire of said several welders; and,
(c) displaying the amounts of wire of said several welders at a remote location.

91. A method as defined in claim 90 including an alarm for each of said welders at said remote location and the method further including:
(d) activating one of said alarms when a transmitted signal indicates a welder has less than a given amount of wire.

92. A monitoring device for sensing of the actual amount of welding wire on a spool with a minimum wire supply diameter for use in a wire feeder of an electric arc welder operated at a known wire feed speed, said monitoring device comprising: an RPM device to create a spool speed signal indicative of the rotational speed of said spool as said spool provides wire at said known wire feed speed, a converting device for converting said spool speed signal into a wire supply signal varying between a high level when said spool speed signal is low at a presumed maximum supply of wire on said spool and a low level when said spool speed signal is high at the minimum supply of wire on said spool determined by said minimum wire supply diameter and a gage for exhibiting at least periodically the actual supply of wire based upon the level of said wire supply signal.

93. A monitoring device as defined in claim 92 wherein said converting device includes a stage for converting said spool speed signal into a linear wire supply signal.

94. A monitoring device as defined in claim 92 including an alarm unit responsive to said wire supply amount decreasing to a set value near said low level.

95. A monitoring device as defined in claim 94 wherein said alarm unit produces an audible alarm.

96. A monitoring device as defined in claim 92 including a device to prevent operation of said welder when said wire supply signal level is below a given amount.

97. A monitoring device as defined in claim 96 including a device for adjusting said given amount.

98. A monitoring device as defined in claim 97 wherein said adjusted given amount is generally related to the amount of wire used for a welding cycle of said welder.

99. A monitoring device as defined in claim 92 wherein said RPM device comprises a readable element on said spool and a sensing element on said welder at a location passed by said readable element during rotation of said spool.

100. A monitoring device as defined in claim 92 wherein said welder includes a rotatable spindle for carrying and rotating with said spool and wherein said RPM device comprises a readable element on said spindle and a sensing element on said welder at a location passed by said readable element during rotation of said spindle.

101. A monitoring device as defined in claim 92 wherein said converting device makes said conversion at closely spaced sampling times.

102. A monitoring device as defined in claim 101 wherein sampling times are spaced at least about 100 ms.

103. A monitoring device as defined in claim 101 wherein said spool speed signal has an empty spool value when said wire on said spool is exhausted and said converter adjusts said empty spool value by adjusting said minimum wire supply diameter.

104. A monitoring device as defined in claim 99 wherein said spool speed signal has an empty spool value when said wire on said spool is exhausted and said converter adjusts said empty spool value by adjusting said minimum wire supply diameter.

105. A monitoring device as defined in claim 96 wherein said spool speed signal has an empty spool value when said wire on said spool is exhausted and said converter adjusts said empty spool value by adjusting said minimum wire supply diameter.

106. A monitoring device as defined in claim 94 wherein said spool speed signal has an empty spool value when said wire on said spool is exhausted and said converter adjusts said empty spool value by adjusting said minimum wire supply diameter.

107. A monitoring device as defined in claim 93 wherein said spool speed signal has an empty spool value when said wire on said spool is exhausted and said converter adjusts said empty spool value by adjusting said minimum wire supply diameter.

108. A monitoring device as defined in claim 92 wherein said spool speed signal has an empty spool value when said wire on said spool is exhausted and said converter adjusts said empty spool value by adjusting said minimum wire supply diameter.

109. A monitoring device for sensing of the actual amount of welding wire on a spool with a minimum wire supply diameter for use in a wire feeder of an electric arc welder, said monitoring device comprising: a device for creating a first signal indicative of the actual diameter of said wire at any given time, a converter for converting said first signal into a wire supply signal varying between a high level when said spool supply is at a presumed maximum supply of wire on said spool and a low level when said spool supply is at the minimum supply of wire on said spool, and a gage for exhibiting at least periodically the actual supply of wire based upon the level of said wire supply signal.

110. A monitoring device as defined in claim 109 wherein said first signal involves a relationship between the rotational speed of said spool and the wire feed speed of said wire feeder.

111. A monitoring device as defined in claim 109 wherein said first signal involves a direct reading of the diameter of the supply of wire on said spool.

112. A monitoring device as defined in claim 111 wherein said first signal has an empty spool value when said wire on said spool is exhausted and said converter adjusts said empty spool value by adjusting said minimum wire supply diameter.

113. A monitoring device as defined in claim 110 wherein said first signal has a an empty spool value when said wire on said spool is exhausted and said converter adjusts said empty spool value by adjusting said minimum wire supply diameter

114. A monitoring device as defined in claim 109 wherein said first signal has an empty spool value when said wire on said spool is exhausted and said converter adjusts said empty spool value by adjusting said minimum wire supply diameter.

115. A monitoring device for sensing of the actual amount of welding wire on a spool with wire supply width and a minimum wire supply diameter for use in a wire feeder of an electric arc welder, said monitoring device comprising: a device using the minimum diameter and width for creating a first signal indicative of the actual volume of said wire at any given time, a converter for converting said first signal into a wire supply signal varying between a high level when said spool supply volume is at a presumed maximum supply of wire on said spool and a low level when said spool supply volume is at the minimum supply of wire on said spool, and a gage for exhibiting at least periodically the actual supply of wire based upon the level of said wire supply signal.

116. A monitoring device as defined in claim 115 wherein said first signal involves a relationship between the rotational speed of said spool and the wire feed speed of said wire feeder.

117. A monitoring device as defined in claim 116 wherein said first signal has a an empty spool value when said wire on said spool is exhausted and said converter adjusts said empty spool value by adjusting said minimum wire supply diameter

118. A monitoring device as defined in claim 115 wherein said first signal has an empty spool value when said wire on said spool is exhausted and said converter adjusts said empty spool value by adjusting said minimum wire supply diameter.
